(19) United States
(12) Patent Application Publication
(10) Pub. No.: US 2016/0153430 A1
(43) Pub. Date: Jun. 2, 2016

(54) Floating wind powered structure

(71) Applicant: Gaby Mahfoud, Montreal (CA)

(72) Inventor: Gaby Mahfoud, Montreal (CA)

(21) Appl. No.: 14/868,433

(22) Filed: Sep. 29, 2015

(30) Foreign Application Priority Data
Dec. 1, 2014 (GB) 1421296.3

(51) Int. Cl. F03D 11/04; F03D 3/04; F03D 9/00; F03D 5/04

(52) U.S. Cl. CPC F03D 11/045; F03D 9/002; F03D 5/04; F03D 9/001; F03D 9/028; F03D 9/025; F03D 3/04

(57) ABSTRACT

A floating wind powered structure consists in a plurality of sail structures laid out in a large circular floating rubber structure several kilometers in diameter that rotates around a central axis. This provides a low speed and large torque on the axis and high speed on the periphery which can then rotate any one of a number of mechanical elements such as energy generators, air compressors, water pumps and/or any combination of mechanical systems. The main forces exerted on the structure are wind (positively) and buoyancy (negatively). Therefore for enhanced performance, the tubes can be multiplied and distanced from each other which lead to a wider platform and bigger sails based on the principle of a catamaran.

### FIELD OF THE INVENTION

The present invention relates generally to wind powered systems but more particularly to a floating wind powered structure.

### BACKGROUND OF THE INVENTION

Wind power is a viable source of clean and renewable energy. Generally, windmills are placed alone or in groups in a landscape. However, the humming noise created by windmills and the constant flickering effect created when the shadows of a blade are projected on an observer limits them from being used near the human population. Furthermore availability of land is limited and costs of installing a windmill farm are high. For these and other reasons, there is more and more use of offshore windmill farms where some of these problems are eliminated. Most of the time, however, such windmill farms pretty much repeat the layout and structures found on land based windmill farms with higher installation costs and the windmill blades rotate on bearings that wear out and need frequent replacement. Furthermore traditional wind generators are limited to power generation via wind alone and wind is not a constant, which results in low and high production cycles. There hence exists a need for a more economical and multi-functional wind energy system which uses additional resources such as air and water to harness and store energy during low wind periods or as per the application desired.

### SUMMARY OF THE INVENTION

In view of the foregoing disadvantages inherent in the known devices now present in the prior art, the present invention, which will be described subsequently in greater detail, is to provide objects and advantages which are:

To provide for a floating wind powered structure that utilizes wind to generate energy, pump water and to compress air that can be stored and used as fuel when combined with water to generate energy using a compressed air and water powered turbine.

In order to do so, the invention consists in a plurality of sail structures laid out in a large circular floating rubber structure several kilometers in diameter that rotates around a central axis. This provides a low speed and large torque on the axis and high speed on the periphery which can then rotate any one of a number of mechanical elements such as energy generators, air compressors, water pumps and/or any combination of mechanical systems. The main forces exerted on the structure are wind (positively) and buoyancy (negatively). Therefore for enhanced performance, the tubes can be multiplied and distanced from each other which lead to a wider platform and bigger sails based on the principle of a catamaran.

The floating circular frame structure is equipped with sail members, a floating circular central axis structure comprising a mast, the frame structure being connected to the central axis structure to be rotatable about an axis defined by the mast, anchoring means to fix the central axis structure relative to a bed of a water body, an outer support structure fixed relative to the floating circular frame structure and guiding the rotational movement of the circular frame structure, energy generating means for generating energy from the rotational movement of the floating structures.

The floating circular frame structure is connected to the mast by a plurality of spokes, preferably above water level.

The mast is rotatable relative to the central axis structure.

Anchoring means fix the outer support structure relative to the bed of a water body.

The energy generating means are arranged between the floating circular frame structure and the outer support structure and/or between the floating circular frame structure and the mast.

The energy generating means are arranged between the rotating mast and the central axis structure.

The sail members are connected to rudders and/or are adjustable by motors.

The floating circular frame structure comprises an outer rail to guide the structure within guiding means of the outer support structure.

The energy generating means are electric generators or air pressurizing means connected to pressure tanks and/or water pumping means connected to overhead water reservoirs.

The structure comprises wind vanes to provide information for orienting the sail members in the desired direction with respect to the wind.

The floating circular frame structure comprises circular tubes.

The floating circular frame structure comprises two pairs of superposed tubes, the lower ones being filled with water, the upper ones being filled with air.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Isometric view of part of the invention.

FIG. 2a-b-c Top view, isometric view and side view showing the compressed air tanks and turbine.

FIG. 3 Side view of central rotating platform with generator

FIG. 4 Top view of the rotating wind wheel showing the positions of the sails according to the wind direction

FIGS. 5a-b Top and isometric views of the fixed outer structure surrounding the rotating wind wheel and holding it in place.

FIG. 6 Isometric view of the frame structure surrounding the two upper flotation tubes of the rotating wind wheel.

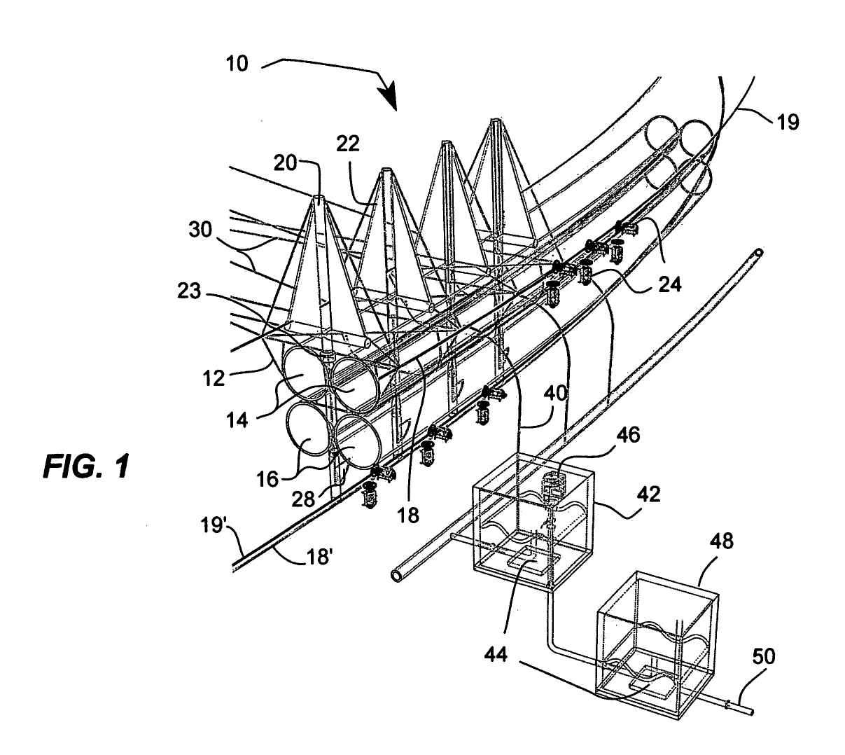

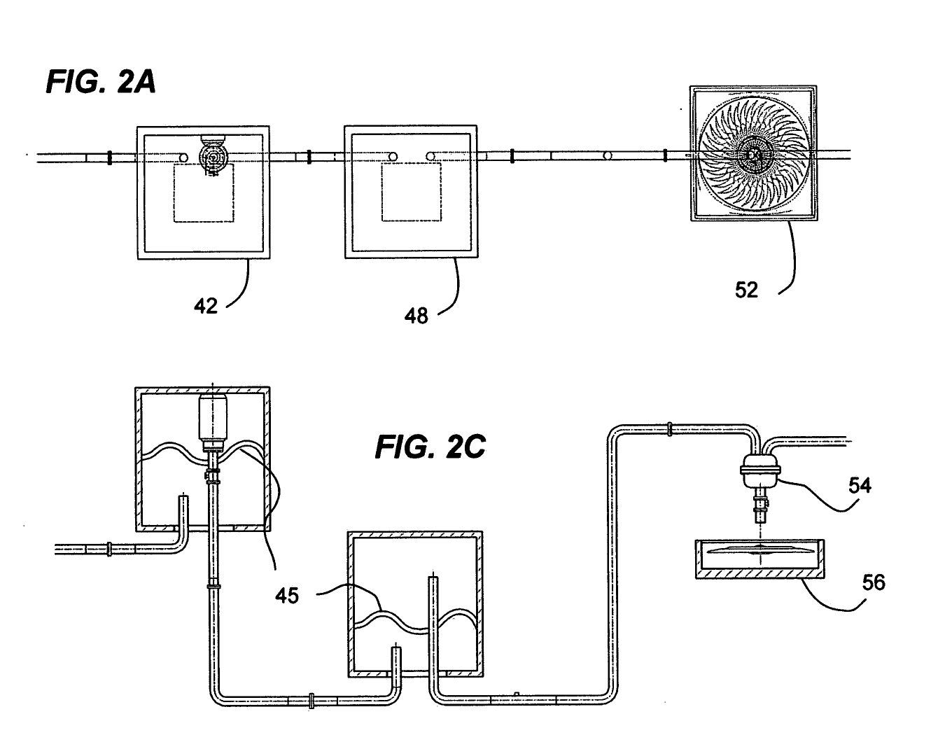

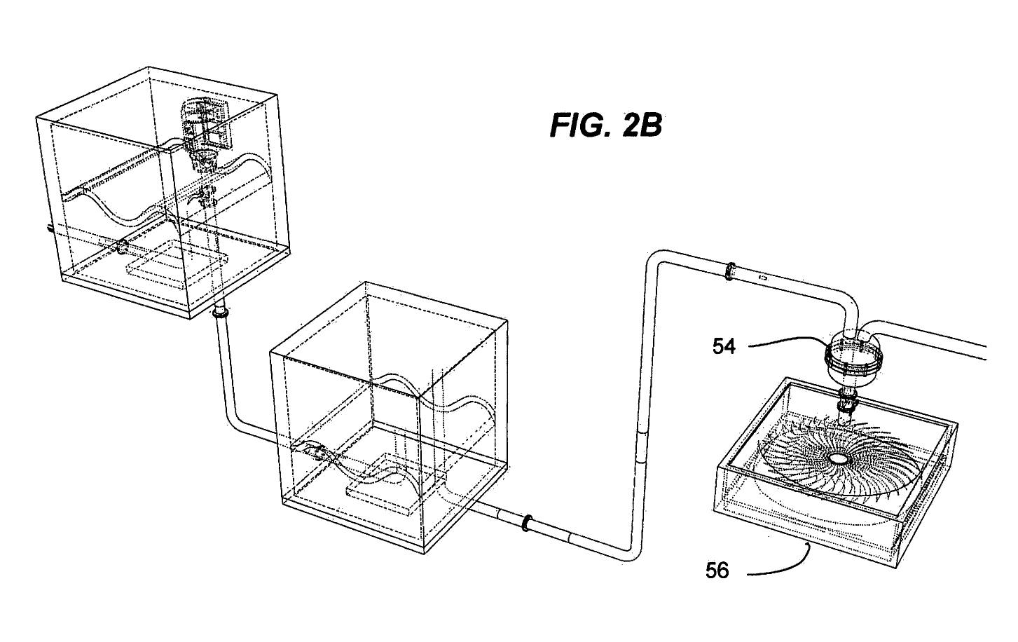

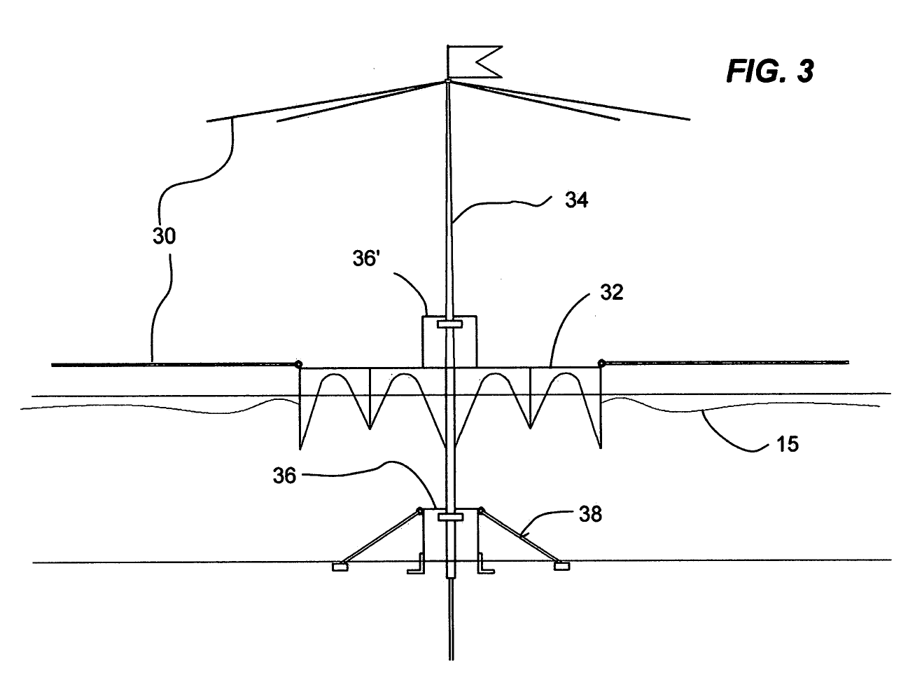

### DETAILED DESCRIPTION

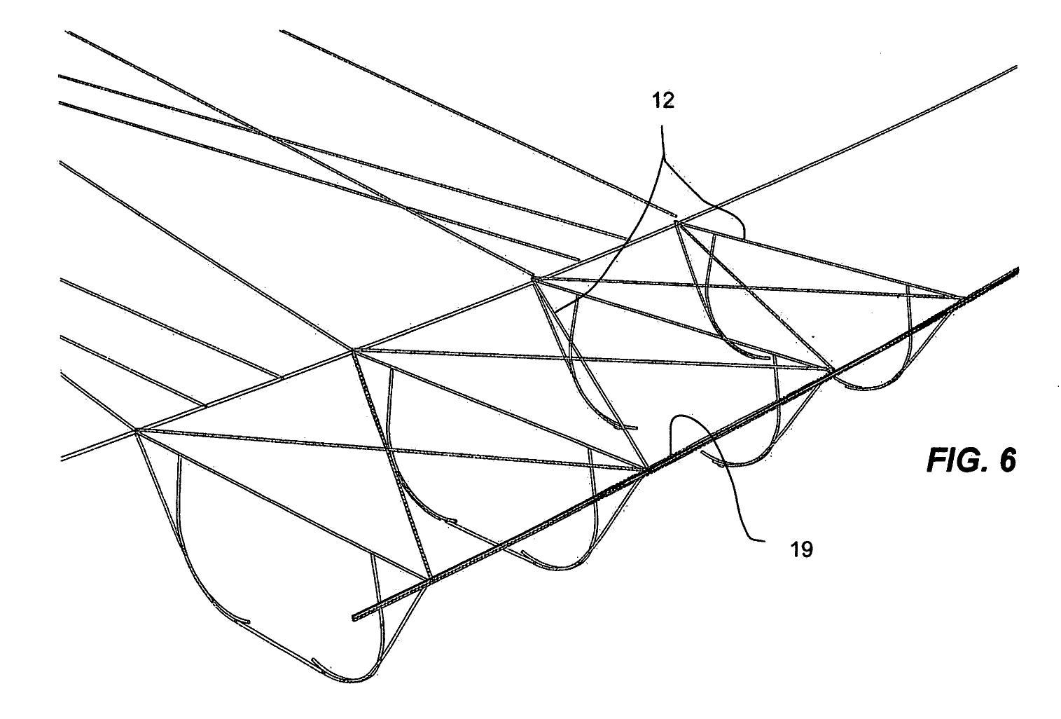

A floating wind powered structure (10) comprising of a circular wind wheel (13) made up of a frame structure (12) shown in FIG. 6 which holds circular tubes (14) filled with air allowing the frame structure (12) to float above water level (15) and circular tubes (16) containing water positioned and held below the circular tubes filled with air (14). The circular tubes (16) contain partitioned compartments of water which add stability to the circular wind wheel (13) and force the water to rotate with the structure. A plurality of sail members (22) attached to mast members (20) are perpendicularly attached to the circular tubes (14 & 16) and spaced apart at regular intervals. The mast members (20) are provided with rudders (28) and motors (23) to help orient the sail members. The circular wind wheel (13) is held in place by an outer support structure (17) provided with two rails, an outer rail (18) and an underwater rail (18′) upon which a plurality of energy generators (24) is positioned. The outer support structure (17) is provided with wind vanes (26) at regular intervals and held by anchors (21) to the bed (25) of the water body.

A plurality of spokes (30), the upper ones filled with compressed air and the lower ones filled with compressed helium connect the circular wind wheel (13) to a floating central axis structure (32) which is provided with an energy generator (36) held below it by an anchoring mechanism (38) on the bed (25) of the water body. In an alternate embodiment the energy generator (36′) is fixed stationary in the middle of the floating central axis structure (32). The circular wind wheel (13) rotates and the spokes (30) spin the central axis structure (32) and turn a rotating mast (34) that runs through the center of the floating central axis structure (32). The rotation of the central axis platform (32) and mast (34) activates and drives the energy generators (36, 36′). An outer rail (19) on the outer circumference of the frame structure (12) is connected via a gear drive mechanism (not shown) to the energy generators (24) positioned along the outer rail (18) of the outer support structure (17) and similarly outer rail (19′) which is attached to the bottom of the mast members (20) is connected to the underwater rail (18′) via a gear drive mechanism (not shown). The sail members (22) rotate the wind wheel (13) which in turn drives the energy generators (24) via the drive mechanisms (not shown) connecting the mast members (20) to the underwater rail (18′) and the energy generators (24) positioned above the water level (15) on the outer rail (18) to the outer rail (19) of the frame structure (12).

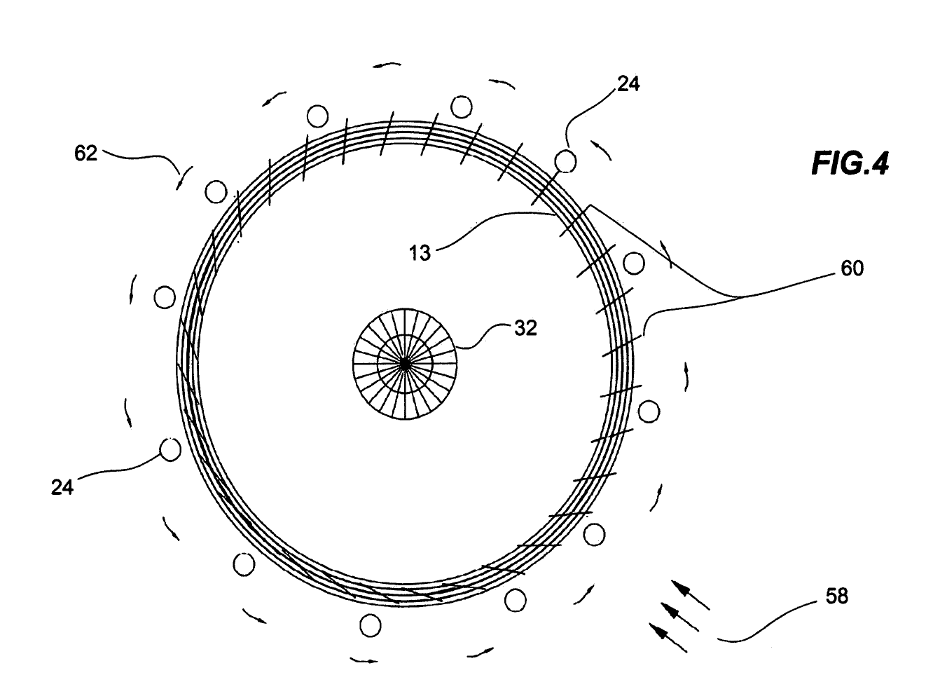

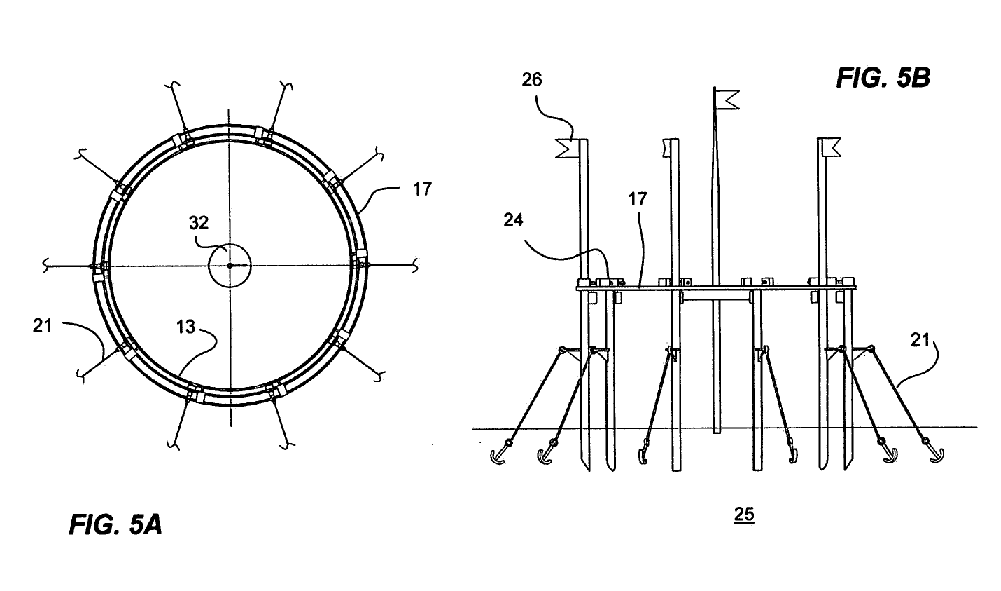

The motors (23) and rudders (28) help orient (60) the sail members (22) in the desired direction so that the wind (58) force is maximum on sail members (22) in the direction of rotation (62) and minimal on sail members (22) that are in a position (see FIG. 4) countering rotation of the circular wind wheel (13). The sail motors (23) in conjunction with the wind vanes (26) reorient the mast members (20) so that the sail members (22) face the wind for the best performance.

In cases where air pressure is used to produce energy, the energy generators (24) which perform as air compressors take in external air and compress it via pipes (40) into an underwater pressure tank (42) positioned under water level (15). The bottom of the underwater pressure tank has an opening (44) that allows water inside. The water pressure from underneath maintains the pressure of the air being driven into the pressure tank (42) from above to contain it at a given pressure. A separate air pump (46) provided inside the underwater pressure tank pushes pressurized air from within the pressure tank (42) to another similar underwater pressure tank (48) via pipes (40) positioned at a lower level under the water level (15) to hold pressurized air at a higher pressure as the force of water pushing from the bottom opening (44) will be higher due to the increased depth at which it is positioned. Pressurized air from this second pressure tank (48) can similarly be passed to a plurality of such tanks positioned at increasingly lower levels below the water level. This pressurized air is released via a exit pipes (50) to an externally located air-water driven turbine unit (52). Compressed air piped from the exit pipes (50) are mixed with water droplets in a high pressure spraying unit (54) and sprayed downwardly onto blades (56), spinning them to produce energy.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A floating wind powered structure for generating energy comprising:
a floating circular frame structure being equipped with sail members;
a floating circular central axis structure comprising a mast;
said frame structure being connected to said central axis structure to be rotatable about an axis defined by said mast;
anchoring means to fix said central axis structure relative to a bed of a water body;
an outer support structure fixed relative to said floating circular frame structure and guiding the rotational movement of said circular frame structure;
energy generating means for generating energy from the rotational movement of said floating structures.

2. The floating wind powered structure according to claim 1, wherein said floating circular frame structure is connected to said mast by a plurality of spokes, preferably above water level.

3. The floating wind powered structure according to claim 1, wherein said mast is rotatable relative to said central axis structure.

4. The floating wind powered structure according to claim 1, wherein anchoring means fix the outer support structure relative to said bed of a water body.

5. The floating wind powered structure according to claim 1, wherein said energy generating means are arranged between said floating circular frame structure and said outer support structure and/or between said floating circular frame structure and said mast.

6. The floating wind powered structure according to claim 1, wherein said energy generating means are arranged between said rotating mast and said central axis structure.

7. The floating wind powered structure according to claim 1, wherein said sail members are connected to rudders and/or are adjustable by motors.

8. The floating wind powered structure according to claim 1, wherein said floating circular frame structure comprises an outer rail to guide said structure within guiding means of said outer support structure.

9. The floating wind powered structure according to claim 1, wherein said energy generating means are electric generators or air pressurizing means connected to pressure tanks and/or water pumping means connected to overhead water reservoirs.

10. The floating wind powered structure according to claim 1, wherein said structure comprises wind vanes to provide information for orienting said sail members in the desired direction with respect to the wind.

11. The floating wind powered structure according to claim 1, wherein said floating circular frame structure comprises circular tubes.

12. The floating wind powered structure according to claim 1, wherein said floating circular frame structure comprises two pairs of superposed tubes, the lower ones being filled with water, the upper ones being filled with air.
